(19) United States
(12) Patent Application Publication
(10) Pub. No.: US 2026/0094017 A1
(43) Pub. Date: Apr. 2, 2026

(54) DYNAMICALLY GENERATING KNOWLEDGE ASSESSMENT ITEMS

(71) Applicant: EXAMROOM.AI CORP., Lake Mary, FL (US)

(72) Inventors: Vinod Kumar JAYAKEERTHI, Sorrento, FL (US); Parshant KUMAR, Bangalore (IN); Ravichandra PANCHAKSHARAM, Bangalore (IN); Deepak Madhukar KOLEKAR, Bangalore (IN)

(73) Assignee: EXAMROOM.AI CORP., Lake Mary, FL (US)

(21) Appl. No.: 19/315,716

(22) Filed: Sep. 1, 2025

Related U.S. Application Data
(60) Provisional application No. 63/690,342, filed on Sep. 4, 2024.
(60) Provisional application No. 63/690,343, filed on Sep. 4, 2024.

(51) Int. Cl. G06N 5/022

(52) U.S. Cl. CPC G06N 5/022

(57) ABSTRACT

Embodiments of the present disclosure relate to a method, a system and a computer program product for generating and/or creating knowledge assessment items for an item bank using artificial intelligence and machine learning.

### RELATED APPLICATION

This application claims the benefit of priority to U.S. Provisional Patent Application No. 63/690,343 filed on Sep. 4, 2024 titled “DYNAMICALLY GENERATING EXAM ITEMS USING ARTIFICIAL INTELLIGENCE”, and U.S. Provisional Patent Application No. 63/690,342 filed on Sep. 4, 2024 titled “ITEM BANK GENERATION FROM A HUMAN PROVIDED SEED EXAM ITEM USING ARTIFICIAL INTELLIGENCE” and co-pending application U.S. Ser. No. 19/251,523 filed on Jun. 26, 2025 titled “AUTOMATICALLY GENERATING KNOWLEDGE ASSESSMENT ITEMS”, all applications herein incorporated by reference in its entirety.

### TECHNICAL FIELD

Embodiments of the present disclosure relate to automatically generating knowledge assessment items, and more specifically generating knowledge assessment items using artificial intelligence.

### BACKGROUND

Generally, knowledge assessment items (also referred to as exam items or simply and broadly referred to as items in the present disclosure) are evaluation tools that may be used to gauge a candidate's understanding and retention of information, concepts or skills. Knowledge assessment items can range from simple quizzes to more comprehensive assessment activities and/or tasks requiring integrated application of knowledge and skills complex performance tasks and are crucial for measuring learning progress and identifying areas for improvement and assessment of candidates. The focus of knowledge-based assessments is on what a person knows and can do with that knowledge, rather than on their ability to recall facts or perform specific tasks. Educational institutions and organizations, including corporates and industries, that are increasingly dependent on conducting online and offline based assessments, where these assessments may be conducted where the candidate is administered a set of knowledge assessment items.

Usually, these knowledge assessment items are created and maintained in an item bank (also referred to as a repository or item bank repository) and are selected for candidates based on some specified criteria. Assessment serves as an evaluation system and is a way to compare performance across a spectrum and across populations. Items need to be created and populated to build an item bank from which items may be selected and administered to candidates for assessing the candidate. Generally, creating or generating an item bank with items by humans is currently a challenging and tedious task and involving relatively large investments of human effort as these human experts need to develop the items with/without keys and/or distractors by reading content and based on their expertise, and such methodologies are typically not cost effective, nor does it save time and effort involved in generating the knowledge assessment items (also referred to as items). There is therefore a need to overcome the traditional approaches and adapt to newer, cost effective and efficient approaches for generating knowledge assessment items under different item types and continuously updating existing item banks or creating new item banks.

### BRIEF DESCRIPTION OF THE DRAWING FIGURES

Whereas novel aspects believed characteristic of the invention are set forth in the appended claims, embodiments described herein will be understood by those of skill in the art with reference to the following detailed description in conjunction with the accompanying drawing figures in which like reference numerals indicate similar or identical features and components.

FIG. 1 illustrates a high-level exemplary architecture 100 for creating items (knowledge assessment items) using an AI/ML module in accordance with an embodiment of the present disclosure.

FIG. 2 illustrates a high-level exemplary environment 200 for creating items (knowledge assessment items) using an AI/ML module in accordance with an embodiment of the present disclosure.

FIG. 3 illustrates an exemplary method of providing inputs to computing system comprising AI/ML module configured for assessing the parameters and generating knowledge assessment items in accordance with the embodiments of the present disclosure.

FIG. 4 illustrates an exemplary method for assessing the parameters and generating knowledge assessment items in accordance with the embodiments of the present disclosure.

FIG. 5 illustrates a method for authenticating the generating knowledge assessment items and updating the item bank in accordance with the embodiments of the present disclosure.

### DETAILED DESCRIPTION

The following describes technical solutions in exemplary embodiments of the subject matter of the present disclosure with reference to the accompanying drawings. In this application as disclosed herein, “at least one” means one or more, and “a plurality of” means two or more. The term “and/or” describes an association relationship for describing associated objects and represents that three relationships may exist. For example, A and/or B may represent the following cases: Only A exists, both A and B exists, and only B exists, where A and B may be singular or plural. The character “/” usually indicates an “or” relationship between the associated objects. “At least one item (piece) of the following” or a similar expression thereof means any combination of the items, including any combination of singular items (piece) or plural items (pieces). For example, at least one item (piece) of a, b, or c may represent a, b, c, a and b, a and c, b and c, or a, b, and c, where a, b, and c each may be singular or plural.

It should be noted that in this application articles “a”, “an” and “the” are used to refer to one or to more than one (i.e., to at least one) of the grammatical object of the article. The terms “comprise” and “comprising” are used in the inclusive, open sense, meaning that additional elements may be included. It is not intended to be construed as “consisting of” or “consists of only”. Throughout this specification defined above, unless the context requires otherwise the word “comprise”, and variations such as “comprises” and “comprising”, will be understood to imply the inclusion of a stated element or step or group of elements or steps but not the exclusion of any other element or step or group of elements or steps. The term “including” is used to mean “including but not limited to”. “including” and “including but not limited to” are used interchangeably. In any structural formulae given herein and throughout the present disclosure, the following terms have been indicated meaning, unless specifically stated otherwise.

Unless otherwise defined, all terms used in the disclosure, including technical and scientific terms, have meaning as commonly understood by one of ordinary skill in the art to which this embodiment of the present disclosure belongs. By means of further guidance, term definitions if any are included for better understanding of the present disclosure. The term ‘about’ as used herein when referring to a measurable value such as a parameter, an amount, a temporal duration, and the like, is meant to encompass variations of at least ±10% or less, preferably at least ±5% or less, more preferably at least ±1% or less and still more preferably at least ±0.1% or less of and from the specified value, insofar such variations are appropriate to perform the present disclosure. It is to be understood that the value to which the modifier ‘about’ refers is itself also specifically and preferably disclosed.

It should be noted that in this application, the term such as “example” or “for example” or “exemplary” is used to represent giving an example, an illustration, or descriptions. Any embodiment or design scheme described as an “example” or “for example” in this application should not be explained as being more preferable or having more advantages than another embodiment or design scheme. Exactly, use of the word such as “example” or “for example” is intended to present a related concept in only a specific manner. In the embodiments of the present subject matter, it should be understood that “B corresponding to A” indicates that B is associated with A, and B can be determined based on A. However, it should be further understood that determining B based on A does not mean that B is determined based on only A. B may alternatively be determined based on A and/or other information. In the embodiments of this present disclosure, “a plurality of” means two or more than two. Descriptions such as “first”, “second” in the embodiments of this application are merely used for indicating and distinguishing between described objects, do not show a sequence, do not indicate a specific limitation on a quantity of devices in the embodiments of this application, and do not constitute any limitation on the embodiments of this application.

Embodiments of the present disclosure relate to a method, a system and a computer program product for generating and/or creating knowledge assessment items (hereinafter also referred to generally as items or exam items or assessment items or evaluation items in the present disclosure and these terms may be interchangeably used in the present disclosure). In an embodiment, the items are generated from the content provided by the source (source hereinafter may refer generally to an examination administrator and/or a client and/or a third party acting on behalf of a client and/or a subject matter expert and/or a user) or from content that is automatically identified from the input requirements specified to an artificial intelligence/machine learning module of a computing system and classifying the content identified as being relevant to the subject area under consideration by the Artificial Intelligence/Machine Learning (AI/ML) module. In an embodiment, the items generated may be used for creating an item bank or updating an existing item bank after vetting the items, wherein vetting of the items may be performed by the AI/ML module and/or by a subject matter expert. In an embodiment, the item bank is typically a repository consisting of a large collection of items that may be collated together and/or categorized and/or catalogued either by the AI/ML module and/or by the source, from which items may be selected for assessing a candidate or for an examination. In an embodiment source may select items to prepare a test package, which contains specific items to be administered for assessment of the candidate, and the selection of items for assessment depends on the requirements of the test package and/or the test specifications, which may also be a part of the test package.

In an embodiment items generated from the content and the input requirements specified to the AI/ML module and may be categorized and/or catalogued by an AI/ML module. In an embodiment, the items generated may be further authenticated and vetted by the source such as a subject matter expert before being uploaded and stored in the item bank under the relevant category/subject area/topic based on the learnings of the AI/ML module. In an additional embodiment, a separate module within the AI/ML module may authenticate the items before the items are uploaded and stored in the item bank under the relevant category/subject area/topic based on the learnings of the AI/ML module. In an embodiment, the subject matter expert may change the relevant category/subject area/topic suggested by the AI/ML module with feedback, and the changes and feedback are provided to the AI/ML module for implementation and self-learning for the AI/ML module. In an embodiment, post categorizing and authentication of the items, the AI/ML module may seek further inputs from the source as required for any further assistance and/or clarification. In an embodiment the input may be at least one or more data sources, wherein a data source may be an origin and/or a location from which data may be obtained. In an embodiment, data source may include and not be limited to a database, a file, a device, or even a web service. In an embodiment, essentially, a data source may be defined as a place where information is stored and accessible for analysis and/or use. In an embodiment, the AI/ML module may be configured to categorize a particular item generated into multiple subject areas and/or topics. In an exemplary embodiment, if the content provided to the AI/ML module for generating items was in the sub-subject area of electricity in a larger subject area of Physics, the items generated under this topic may be found by the AI/ML module to be of interest to other subject areas such as Electrical Engineering, Mechanical Engineering etc., in which case, the AI/ML module may provide recommendations to the source on these findings and request for validation of the items in the other identified subject areas/topics to be confirmed by a subject matter expert. In an exemplary case, if the items are found to be valid or determined to be valid in the identified subject areas/topic, the AI/ML module may be configured to update the items in the item bank under the newly identified subject areas/topics. In an embodiment, the input received from the source for generating the items may be structured data, unstructured data or a combination thereof.

In an exemplary embodiment, the items (knowledge assessment items) may be created by an artificial intelligence module and/or a machine learning module (AI/ML module). In an embodiment, an existing item bank may be updated by the newly created items once the items have been vetted and the AI/ML module determined that the items are not being duplicated in the item bank. In an embodiment, the AI/ML module on detection of the items being duplicated, provided an indicator to the source that the items already exist in the item bank. In an embodiment, the AI/ML module may identify new subject areas/topics and may create such subject area/topics in an existing item bank and update the items under the newly created subject area/topic after validation by the source. In an exemplary embodiment, the AI/ML module is provided with an input from a source, wherein the input is a typical requirement for creation of items, which may also include data sources as defined previously. In an embodiment, the input from a source is received by the AI/ML module, and as disclosed previously may be in a structured format, unstructured format or a combination thereof. In an embodiment, the input for generating items may include content for generating items, at least one or more item type to be generated from the content, at least one or more subject areas in which the items are generated, at least a number of items to be generated under each item type, amongst other parameters from a set of pre-defined parameters, wherein the set of pre-defined parameters may be dynamically updated with newer parameters with the learnings from the AI/ML module. In an embodiment, the input received from the source at least has a minimal set of pre-defined parameters required as a mandatory set of parameters for the AI/ML module to execute the input and generate the items. In an embodiment, other parameters may include and not be limited to identifying duplicate items and deleting the duplicating items in the same item type category, and it should be obvious to a person of ordinary skill in the art that various other parameters may be included for generation of items as envisioned with respect to the embodiments of the present disclosure and all such variations fall within the scope of the present disclosure.

In an embodiment, the AI/ML module may be configured to determine or identify multiple subject areas/topics closely related to an item generated and provide a classification and/or categorization for the item. In an embodiment, on vetting the item, the item is updated to the item bank, where vetting the item may be performed by the AI/ML module and/or an external source, such as a subject matter expert. In an additional embodiment, the AI/ML module may be configured to automatically identify relevant content for generating items based on the input provided to the AI/ML module, when the content for generating items is not specified in the input as part of the requirement, where in an exemplary case the input may specify a subject area and the number of items is specified and the number of items types is specified. In an exemplary case, when the subject area is specified as Physics and motion, the AI/ML module may be configured to automatically identify source of content and use that content to generate the items, where the content may be validated by the source, depending on the capability and confidence of the AI/ML module. In an additional embodiment, the AI/ML module may seek clarification from the source if the parameters defined in the input are insufficient and/or unclear for generating items, such that for example relevant content may be identified based on the input provided to the AI/ML module, when content is not specified. In an embodiment, the AI/ML module may be configured to, based on the content and the set of pre-defined parameters (which essentially includes at least a minimal set of parameters), prepare new items under the specified item type in the input and also classify the items under other different item type categories. In an exemplary embodiment, the content may be from a book or from any other source available publicly or any other documented source, which may be in audio form or in video form or published or any other multi-media form, wherein in one instance the AI/ML module is provided with the functionality to search for the relevant content, ensuring the content sources used for generating items are complaint with any statutory regulations. In an embodiment, the AI/ML module is trained to check the content for any statutory regulation and acknowledge the statutory regulations and/or intimate the source regarding any statutory regulations before being used in generating items.

In an embodiment, based on the at least one or more item types and the subject area provided as input, the AI/ML module may be configured for fetching (hereinafter also referred to as accessing or retrieving) relevant content from at least one or more content sources relevant to the subject area. In an embodiment, fetching content additionally includes analyzing the content for relevance and discarding the content with or without consultation of the source if the content is not relevant to the input query. In an exemplary case, if the input specifies subject area Physics and electricity, and if the content fetched is general physics related to optics, the content is found to be irrelevant to the subject area and/or not in conformity with any statutory regulations, and the AI/ML module may be configured to discard the content. In an embodiment, if the content source is not provided by the source, the AI/ML module may automatically identify content sources or previously referenced content sources, where links to previously reference content source are stored locally, in the relevant subject area for generating items as per the requirements in the inputs specified, and such content sources may be derived from self-learning data and training data that may be accessed by the AI/ML module. In an embodiment, reference to previously referenced content sources may be stored as links in a lookup table locally in a server mapping the content source to the link for quicker access to relevant content sources. In an embodiment, a search engine may be integrated with the AI/ML module for searching content sources and providing the content sources to the AI/ML module, which may reference the content wherein the content satisfies statutory regulations after the AI/ML module checks the content sources for such regulations. In an embodiment, the AI/ML module is further configured for dynamically creating at least one or more items in the one or more item type, wherein the AI/ML module may be provided a limit on the number of items or the number of item types or the number of items under each item type category as one of an additional pre-defined parameters. In an embodiment, as mentioned previously, the items refer to knowledge assessment items or exam items or evaluation items. In an embodiment, the AI/ML module may be further configured for providing as output at least one or more items to the source. In an embodiment, the items are dynamically and/or automatically generated from the content and input parameter (also referred to as requirements as set forth in the set of pre-defined parameters) provided to the AI/ML module.

In an embodiment, content may be fetched from at least one of a local source or a repository or the internet or a book or a journal or a combination thereof, where a combination thereof refers to relevant content being taken from multiple sources for generating items from the input requirements. In an embodiment, content used for creating items may be referenced and the links to the content may be remembered and stored by the AI/ML module for future use, where similar content requirements may be required. In an embodiment, the source is at least one of and not limiting to an examination administrator and/or a client and/or a third party acting on behalf of a client and/or a subject matter expert and/or a combination thereof. In an embodiment, the items created may be authenticated and further vetted by the source, preferably a subject matter expert, wherein the item may be checked by the subject matter expert and any recommendation regarding the categorization of the item or any corrections request with respect to the items may also be checked prior to adding the item to an item bank. In an embodiment, if there is any discrepancies detected and/or any feedback associated with the items from the source, the feedback may be given to the AI/ML module which is a self-learning module that will adapt the changes and learn from the feedback provided by the subject matter expert, and incorporate the learnings in future use of the AI/ML module for generating items. Embodiments of the present disclosure also may use a Human-in-the-loop (HITL) approach, where the AI/ML module of the system may be designed to integrate human expertise, where the human is at least one of an examination administrator and/or a client and/or a third party acting on behalf of a client and/or a subject matter expert and/or a user), with machine learning or AI to improve performance, accuracy, and reliability, and may be a collaborative approach where humans and machines work together, with human input used to train, refine, and validate the AI model.

In an exemplary case, the content may include at least one of and not be limited to an audio source, a video source, an audio-visual source, a journal, publications, web pages, books, any multi-media source, or a combination thereof. In an exemplary case, the content may be provided via different sources/formats such as an optically scanned content, a web page, a link to a web page, a blog, an optical disc etc. In an exemplary case, multiple options may be provided for creating items with respect to the content. In an exemplary case, the subject may include certain chapters of books and a link to a web page which describes the content. It should be obvious to a person of ordinary skill in the art that any information and/or data may be selected and used as content to be provided as input, and all such information and/or data falls within the scope of the present disclosure. In an exemplary case, the AI/ML module may be integrated into a computing system in terms of a software, as a hardware, as a firmware and/or a combination thereof.

In an embodiment, the AI/ML module may assign a difficulty score or a threshold score for each item that is created. In an alternate embodiment, the subject matter expert may assign a difficulty score or a threshold score for each item that is created. In an alternate embodiment, the subject matter expert may vet the difficulty score or threshold score assigned by the AI/ML module and further provide feedback on any reassignment of the difficulty score or threshold score to the AI/ML module for the purpose of self-learning and self-training. In an embodiment. content may include automatically fetched by the AI/ML module from a content source in the relevant subject area. In an alternate embodiment, fetching content may include requesting the source to manually provide the content source in the relevant subject area. In an exemplary case, EXAMROOM.AI® proprietary software FIGMA® for generating items from an input, is configured to analyze the input and the content and is configured to generate items in a large set of item types. In an exemplary case EXAMROOM.AI® has defined about 180 different item types and a few of these item types have been listed below and it should be obvious to a person of ordinary skill in the art that various other new item types may be defined using different permutations and combinations all such new variation of item types fall within the scope of the embodiments of the present disclosure, where irrespective of the item type, if items are generated using the AI/ML module as disclosed herein, such variations fall within the scope of the embodiments of the present disclosure.

In an exemplary case, a number of different item types that may be generated from the relevant content are listed herewith. An exemplary case may include an item type of multiple-choice items, where multiple choice questions are a question type in which the candidate has to select one (single select multiple choice question), and the multiple-choice question consists of an incomplete stem (question), correct answer, incorrect answers or distractors. Another exemplary case may include an item type of multiple response singular correct item, where the item gives the candidate options to select and respond to a stimulus where only one response should be selected. Another exemplary case may include an item type multiple response multi correct item, where the candidate may be required to select all that apply, where under this item type, the candidate should be able to select any number of alternatives. Another exemplary case may include an item type of multiple response select N item, where the candidate may be required to select N from a set M provided, and in this item the candidate may be able to select a fixed (N) number of alternatives from a set of M alternatives, and in one specific case N=M. Another exemplary case may include an item type of multiple response grouped item, where in this item the candidate may select multiple alternatives, however the alternatives are grouped.

Another exemplary case may include an item type of drop-down cloze item, where the item is a variation of multiple-choice item, however there may be more than one multiple choice item in the form of drop-down blocks within a sentence. Another exemplary case may include an item type of drop down in table, where dropdown Table response gives the candidate a table of information and dropdowns in different parts of the table, which may provide the candidate with a holistic look at data best shown in a table to fill out with respect to the question. Another exemplary case may include an item type of drag and drop cloze item, where the item is a variation of multiple-choice item; however, it may have more than one multiple choice item in the form of drag and drop blocks within a sentence, and the drag and drop cloze response give the candidate a paragraph of information, and one or more response areas to drag a token. Another exemplary case may include an item type of bowtie drag and drop item, which is a unique item and has three stages for the candidate to provide answers, and essentially the number of options to drag and drop could be configurable.

Another exemplary case may include an item type of is highlighting in text item, where highlight in the text gives the candidate a paragraph of information, and the candidate is then asked to select parts of the item to determine what is critical for the action. Another exemplary case may include an item type of is highlight in table item, where highlight in the table gives the candidate a table of information, and the candidate is then asked to select parts of the item to determine what is critical for the action. In this item a set of phrases could be highlighted and the phrase to be highlighted could be in the form of token, and the phrases may be available in each row of a table. Another exemplary case may include an item type of matrix grid multiple choice item, where matrix multiple choice is an extension of multiple choice, but in a grid format, such that each row has a multiple choice question, and the matrix multiple choice response gives the candidate a set of statements and a choice of two or three responses to each and the candidate selects one per line response. Another exemplary case may include an item type of matric grid multiple response, which is an extension of multiple responses, but in a grid format, such that each column is a multiple response question, and gives the candidate a set of statements and a choice of many responses to each, where for this item, each response could have multiple correct responses and each response is a column.

Another exemplary case may include an item type of fill in the banks with test item, where the candidates may type their responses into response boxes that have been placed into a passage of text. Another exemplary case may include an item type of medical coding, where question addresses the candidate's knowledge of medical coding practices and the main types of codes they will be dealing with. Another exemplary case may include an item type of drop-down—rationale, dyads and triads, where the item involves dropdown in dyads and triads, and the dyads involve a pair of dropdown blocks and triads involve a triplet of dropdown blocks. Another exemplary case may include an item type of drag and drop—rationale, dyads and triads, where the item involves drag and drop in dyads and triads, and the dyads involve a pair of dropdown blocks and triads involve a triplet of dropdown blocks. Another exemplary case may include an item type of graphic item where the candidate chooses from amongst graphic responses, wherein the graphic responses are typically images.

Another exemplary case may include an item type of true or false item (binary input item), where the dichotomous question is generally a Yes/No (True/False) close-ended question and used for basic validation, which can either be provided as radio button type or manually entering True or False into an input section. Another exemplary case may include an item type of rank order scaling item, where the rank order question type allows the respondent to rank preferences in a question in the order of choice. Another exemplary case may include an item type of test slider item, such as a rating scale type, where this type of item uses an interactive slider in answer to select the most appropriate option, and the options scale is well-defined and on the same continuum, such as rating scales being used to measure the direction and intensity of attitudes. Another exemplary case may include an item type of text item where a text question is similar to a comment box, it's a text response, but the data to be entered is generally regulated and requires validation. This item type of question has three sub-types, comprising a single row text where only one line text can be input, numeric textbox, where only numbers may be entered, and specific request such as email address, where an email address may be entered for future correspondence.

Another exemplary case may include an item type of essay with rich text, where essay type answers may be provided with a limitation on the number of words, for example 5000 words, and may include text formatting controls. Another exemplary case may include an item type of essay with plain text, where essay type answers may be provided with a limitation on the number of words, for example 5000 words, and does not include any text formatting controls. Another exemplary case may include an item type of Likert scale item, which is unipolar five point scale item, where this type of question is essential for measuring a candidate's opinion or belief towards a given subject, and the answer options scale is typically a five, seven, or nine-point agreement scale used to measure respondents' agreement with various statements, where the Likert scale is unipolar, indicating a respondent to think of the presence or absence of quality. Another exemplary case may include an item type of Likert scale item, which is a bipolar sever point scale, where the Likert scales may be bipolar such as a seven-point scale or nine-point scale, mentioning two different qualities, and defining the relative proportion of those qualities.

Another exemplary case may include an item type of semantic differential scale item, which is a type of question that asks people to rate a product, company, brand, or any “entity” within the frames of a multipoint rating option. Another exemplary case may include an item type of Stapel scale questions, which is a close-ended rating scale with a single adjective (unipolar), developed to gather respondent insights about a particular subject or event, and the survey question includes an even number of response options without a neutral point. Another exemplary case may include an item type of constant sum question item, which is a rank order question type where the candidate can only select options in the form of numeric, and a constant sum question allows candidates to enter numerical values for a set of variables but requires them to add up to a pre-specified total, where each numeric entry may be summed and may be displayed to the candidate, and is useful in financial questions, budget-related questions, or percentage-based questions. Another exemplary case may include an item type of comment box open ended question item, where an open text format is provided such that the candidate can answer based on their complete knowledge, feelings, and understanding, and therefore, this question type is used when the organization conducting the study would like to justify a selection to a prior question or when extensive feedback is required from the candidate.

Another exemplary case may include an item type of contact information question item, where this question type is an open-ended question with multiple rows of text indicated with a title, and the textual characters are regulated, and in an exemplary case this type of question may collect respondent information like full name, address, email address, phone number, age, etc. Another exemplary case may include an item type of a demographic questionnaire item, where this type of demographic question captures the demographic data from a given population set, and in an exemplary case may be used to identify age, gender, income, race, geographic place of residence, etc. Another exemplary case may include an item type of side-by-side matrix question item, where in case of having to organize a survey to know the importance and satisfaction level of the various services offered to users, this kind of side-by-side matrix question may be used, and it gives the option to define multiple rating options simultaneously. Another exemplary case may include an item type of star rating question item, where the item is a type of rating question that uses an odd number of stars to rank attributes or display feelings and emotions, and higher the number of stars, higher is the agreement with a statement, and this item type allows for a rating on multiple rows to be collected for one single topic.

Another exemplary case may include an item type of maximum differential scaling item, which is a question type where candidates are given a set of attributes and asked to indicate the best and the worst attributes, and there could only be one of each option in the final response. Another exemplary case may include an item type of push to social question item, where the item allows to share reviews or feedback to social media sites like Facebook, Twitter, etc., and is used to create a positivity about the brand on social media, or alternatively, this may also address customer satisfaction issues and negative feedback before being made public on social media. Another exemplary case may include an item type of visual analog question item, where the item is a close-ended question that may be administered in two ways—a Thumbs Up or a Thumbs Down question type and an odd-point smiley question, and thumbs up and thumbs down question is a two-point question where candidates have to indicate their feelings or opinions with either a positive or negative answer. Another exemplary case may include an item type of is another form of a visual analog Simley query item, where a smiley rating question type generally consists of a 5 point rating scale indicated with a neutral point, and due to the question's visual representative nature, the response rate for this question type is always higher.

Another exemplary case may include an item type of net promoter score NPS) item, which is a question type sent to customers to get a concise understanding of their satisfaction level with the brand or organization, and this question is imperative for understanding the level of customer satisfaction, and the response to this question is measured on a scale of 0-10. These may be classified as Detractors—Who gave a score between 0 and 6; Passives—Who gave a score between 7 and 8; and Promoters—Who gave a score between 9 and 10. The scale may be variable. Another exemplary case may include an item type of Van Westendrop-price sensitivity item, is a technique for market researchers to gauge consumer perceptions of products or services' value, and it helps in understanding the scope to tweak the price and offering. Another exemplary case may include an item type of Date and time question item, which is a question type allows to collect date/time information filled in by a candidate consistently.

Another exemplary case may include an item type of is captcha question item, where this question type is used to limit the responses in a survey or data collection by automated computer programs. Another exemplary case may include an item type of is calendar question item where calendar question allows the candidate to input a date and time in the calendar format. Another exemplary case may include an item type of reference data item, where this type of question can be used to validate zip codes against those in the databases for a given country, where for example, if a candidate fill in the zip code and need to check if it's correct as per standard US postal zip code, this question type can be of assistance. Another exemplary case may include an item type of a lookup table question item where the lookup table question type offers to autocomplete information systematically and is a mix of dropdown and single-line editable textbox, where this question type is used when there may be many options, and the correct choice is displayed when the respondent starts typing.

Another exemplary case may include an item type of a tube-pulse item, where this question type allows the candidate to provide feedback or indulge in a discussion about a specific topic, and the stimulating subject is depicted in a video. Another exemplary case may include an item type of constructed response item, where the constructed response gives the option to the candidate to enter text or draw as response to the question, and the character limit could be set for the candidate response, and the candidates could use a drawing tool for drawing the response, and the candidate could have the ability to type in the answer or use the drawing tool or use both methods of response, which may be based on the configuration provided. Another exemplary case may include an item type of multiple binary items, where the item would have a stem and the alternatives below, and the candidate instead of selecting alternatives in a single radio button or checkbox, would have to select a toggle button with two states for all the alternatives shown. Another exemplary case may include an item type of numerical response item, where the candidate will have a stem displayed and a field to enter the number, and the item writer could also set a tolerance for the answer to decide whether the answer is right or wrong.

Another exemplary case may include an item type of graphic gap match item, also referred to as drag and drop, where the candidate would view a paragraph along with an empty area to drop alternatives, and the item could also have only the area to drop and not even a paragraph of text; and the candidate could view the list of alternatives in terms of graphics, which resembles the drag and drop cloze item. Another exemplary case may include an item type of a hot spot item, where the candidate could see an image shown, and the candidate could click on the image at different areas to select the hot spot, and certain areas are fixed as the right answer and certain areas as wrong by the item writer, the candidate will be scored based on the location of the hot spot on the image.

Another exemplary case may include an item type of label image with text item, where this question allows candidates to enter text into labels positioned on an image, these questions are created by uploading your image, positioning the responses and previewing the candidate's response areas in the live editor. Another exemplary case may include an item type of label image with drag and drop item, where with the label image drag and drop question, candidates can select from a list of potential answers and drag them to the correct label on the image. Another exemplary case may include an item type of label image with dropdown item, where in the image drop down question type, candidates select their response from a response box drop down menu located on an image. Another exemplary case may include an item type of categorize with drag and drop item, where this type of classification question allows candidates to categorize a list of possible responses, which may be in the form of words or images or any other format into a table.

Another exemplary case may include an item type of interactive maps questions item, where the questions allow a candidate to click on a location by clicking on an interactive map, and when the candidate scrolls over the map, a selection can be made based on the pop-up at the point of hover. Another exemplary case may include an item type of ordered list item, where labels or alternatives are shown as in a multiple choice item or a multiple response item, along with a clickable area next to the alternatives, and the candidate could click on the clickable area next to the alternative and the ranking is given to each alternative based on the order of the click, for example, the alternative which gets the first click will be ordered as ‘1’ and the other alternatives are ranked subsequently. Another exemplary case may include an item type of ordered list by drag and drop item, where the candidates are asked to order alternatives in a proper manner by re-ordering them with drag and drop. Another exemplary case may include an item type of ordered list—images item, where it is the variation of order list item and order list by drag-and-drop, but the alternatives are graphics/images.

Another exemplary case may include an item type of match list items, where this allows candidates to drag and drop elements to create matched pairs, and this question type can be used to evaluate how candidates create associations and relationships between two lists of items, which for example may be a good fit for subjects like history and geography. Another exemplary case may include an item type of matric multiple choice—inline item, where inline format is a type where there are underscores inside the stem, and choices are displayed as a dropdown for a candidate, and this item type equals the cloze drop down. Another exemplary case may include an item type of matric multiple choice—yes/no, where the item is with two option columns (yes/no) in a table. Another exemplary case may include an item type of sort list item, where the sort list question challenges candidates to drag, highlight, and move items to cluster them into groups. Another exemplary case may include an item type of audio recorder item, which represents the an Audio response, with block layout, and candidates can record audio responses and save it. Another exemplary case may include an item type of video recorder item, which represents video and audio response, and candidates can record a video/audio response and save it.

Another exemplary case may include an item type of chemistry formula item, with or without images, where this question makes it easy to ask candidates to input partial, or full chemical formulas, and the questions can be text or image based. Another exemplary case may include an item type of chemistry formula cloze dropdown and/or, which is another way to deliver formula questions, the cloze chemistry question lets candidates fill in the blanks in a formula by choosing numbers and symbols from a selection dropdown. Another exemplary case may include an item type of chemistry formula cloze drag and drop, which is another way to deliver formula questions, the cloze chemistry question lets candidates fill in the blanks in a formula by choosing numbers and symbols from a selection by drag and drop option.

Another exemplary case may include an item type of flexible, interactive charts for any subject items, where easily bar charts, line charts, histograms, dot plots and line plots may be created, and authors can create interactive charts to engage learners and/or candidates, choose from a host of layout options, and customize the x and y axis and chart labels, and authors have the option to pre-populate the chart with the amount of data as desired. In an exemplary case bar chart items may be designed to drag the charts to match the appropriate value. In an exemplary case line chart item may be designed to drag the points on the graph to their corresponding amount. In an exemplary case histogram item may be designed to drag the bar chart for a particular case, for example for a particular year like 2020, to the appropriate value. In an exemplary case dot and line pot item may be designed to drag the dots to complete the dot plot.

Another exemplary case may include an item type of graphing items, where the graphing question allows the candidates plot points, lines, and shapes on a coordinate grid, and customize the graph to suit the needs of the question; show or hide certain elements, plot points, lines, or shapes, and label them for the candidate as needed, and the candidate submits a response on the graph with a couple of clicks, which for example may be plot the points directly onto the graph or click on the graph to plot the line. Another exemplary case may include an item type of bisect lines and angles item, where the drawing question builds on the image highlight question and provides additional functionality such as a compass, line tool and an eraser, and for example may include using the compass and line tools to construct a response, where candidate should be able to use the compass and line tools to construct the response.

Another exemplary case may include an item type of cloze math with image item, where the question type allows students to label an image, such as a geometric shape, with a math equation response, and the questions can be validated with advanced math-specific scoring methods. Another exemplary case may include an item type of cloze math item, where in this type of item the candidate enters a math response into a response box or several responses as set by the author, and this can then be placed on multiple lines as part of an equation, or in line with text. Another exemplary case may include an item type of math essay with rich text, where the question type allows candidates to input text and advanced math equations within the same answer, allowing candidates to clarify their thought process to teachers, and is subjective and cannot be auto-scored. Another exemplary case may include an item type of math with units item, where this item type allows usage of SI/US units within math. Another exemplary case may include an item type of math with matrices, where math with matrices question allows candidates to enter their responses easily in predefined fields. Another exemplary case may include an item type of math with text, where the math with text question allows candidates to add text after the response box. Another exemplary case may include an item type of math with fill in the blanks, where the question allows candidates to enter their responses in predefined blank boxes. Another exemplary case may include an item type of math with fractions, where the question allows candidates to easily enter complex math equations with fractions in their responses. Another exemplary case may include an item type of math formula, where the question allows candidates to easily enter complex math equations in their responses with advanced validation capabilities using math-specific scoring method.

Another exemplary case may include an item type of shading from platform item, which allows candidates to select areas on a grid, as responses. Another exemplary case may include an item type of graphing in the first quadrant item, where the item type is the same as the graphing item, but differs since the task is set in the 1st quadrant of the graph, where the first quadrant is the upper right-hand corner of the graph, the section where both x and y are positive. Another exemplary case may include an item type of number line drag and drop item, which represents placing responses on a number line, by drag and drop option. Another exemplary case may include an item type of number line with plot item, which includes plotting responses on the number line.

Another exemplary case may include an item type of material items, where the material gives the candidate the content needed to respond to the items, and it may include notes, results from labs, etc., where the material may be presented as tabs, or as a traditional set of text, without tab formatting, and on any given item, there may be up to 6 tabs. As a candidate moves through a case study, more tabs may be added to items and/or updating previous tabs may occur. The identical tabs may be shared between multiple items in one case. Another exemplary case may include an item type of store locator question item, where this question type helps to locate a nearby store in a region for business purposes within proximity of an address or area. Another exemplary case may include an item type of evidence based selected response, where this is usually a combination of two items delivered to the candidate, this could be a combination of multiple choice and multiple response, and the first question to the candidate could be the actual question and the second question could be the evidence for the answer to the first question, where the two items are usually delivered as a pair and the second question is evaluated only if the first question is answered right.

As a purpose of illustration, about 95 item types have been illustrated above, and it should be obvious to a person of ordinary skill in the art, that several other variations and combinations of item types may be derived and generally all item type defined above and new item types that may be devised using the AI/ML module for generating the items in any item type category fall within the scope of the embodiments of the present disclosure. In an exemplary case, for generating items using the AI/ML module using relevant content, the source may provide an exemplary set of 19 item types from the above listed item types including Multiple choice—one correct; Multiple correct—select all; Multiple correct—select N; Dropdown Cloze; Dropdown Rationale; Dropdown Table; Matrix multiple response; Matrix multiple choice; Bow Tie; Highlight in Text; Highlight in Table; Multiple response grouping; Ordered Response; Calculation; Text; True False; Drag Drop Cloze; Paragraph; Paragraph Track Changes of input type items, and the AI/ML module will be configured to generate items in each item type category specified. The number of items to be defined in each item type may also be provided, for example Multiple choice—one correct, 10 items; Multiple correct—select all, 20 items; Multiple correct—select N, 15 items; Dropdown Cloze, 5 items; Dropdown Rationale, 5 items; Dropdown Table, 2 items; Matrix multiple response, 3 items; Matrix multiple choice, 2 items; Bow Tie, 5 items; Highlight in Text; Highlight in Table, 10 items; Multiple response grouping, 5 items; Ordered Response, 10 items; Calculation, 10 items; Text, 20 items; True False, 25 items; Drag Drop Cloze, 25 items; Paragraph, 7 item; Paragraph Track Changes of input type items, 10 items. It should be also obvious to a person of ordinary skill in the art that various other variation and permutations and combination of the item types and items may be devised and all such fall within the embodiments of the present disclosure, when an AI/ML module is used for generating any item type. It should also be obvious to a person of ordinary skill in the art that any new classification of item types, which may fall under one of these above mentioned item types or new item types, but used for generating item under any classified category of the embodiments of the present disclosure or unclassified category of the embodiments of the present disclosure fall within the embodiments of the present disclosure. In an exemplary case, it should be obvious to a person of ordinary skill in the art that a new item type may be devised such as drag on ruler/scale, wherein the question may provide a ruler with markings and the candidate may be asked to mark the size of a foot 3.5 child foot size, 7 adult foot size etc., which may be a single type question or multiple options, and various color marking may be provided to the candidate to provide the said marking for the item, and in one embodiment may also be referred to as a Brannock item, which uses the Brannock scale, and all such new item types that may be devised fall within the scope of the embodiments of the present disclosure, and other variation may be devised of the same as using a scale with other measurements including factional as a new item type category. Essentially, the AI/ML module generates items in all required item type specified by the source and irrespective of the item type used, if the items are generated from content, such instances fall within the scope of the embodiments of the present disclosure.

In an embodiment, the items generated by the AI/ML module may include at least one of a dichotomous type or a polychotomous type. In an embodiment, the item comprises at least a stem, at least a set of keys, at least a set of distractors, and at least an input requirement as an answer to be provided for a stem. In an embodiment, the AI/ML module may be configured for eliminating duplicates items in the same item type category, where for example an item created in one item type category such as matrix multiple choice may also reflect in a different form in another item type category such as True or False, and the difficulty level associated with the same item being assigned in different item type categories may differ, and such items are not deleted as they belong to different item type category and have a different difficulty level. In an embodiment, if the source chooses the same item in different type categories, the AI/ML module may intimate the source regarding the duplicity of items for a given test package, while selecting items for a test package. In an exemplary case, an item assigned to multiple choice may be assigned a threshold score or difficulty score of 2.549 out of 3, whereas the same item when addressed and assigned to true or false may be assigned a threshold score or difficulty score of 2.167 out to 3, where 3 is a score of highest difficulty, and in generally the score may range anywhere from −infinity to +infinity. In an embodiment, the threshold score or difficulty score will be mapped along with the items in the item bank, and the score will be visible to the source for selection of appropriate items with appropriate difficulty level for a given test package. In an embodiment, assigning a threshold score helps in proper selection of the items for the relevant assessment that is being administered to the candidate.

In an embodiment, the scoring may include techniques such as semantic similarity evaluation (SSE) and/or learning language models and/or score aggregation and partial result handling and may be additionally used for assigning a score to the items generated. In an embodiment, semantic similarity evaluation is the process of assessing how similar two pieces of text are in meaning, rather than just surface-level word matching, and is a core concept in natural language processing (NLP), essentially, it determines how closely two texts convey the same idea or concept. In an embodiment, SSE focuses on the underlying meaning of text, not just the words used, and aims to understand the relationship between concepts and ideas expressed in the text. In an exemplary case, “car” and “automobile” would be considered semantically similar, while “car” and “airplane” would not, despite both being nouns. In an embodiment, LLM-based scoring may be used to assign scores to items generated instead of relying solely on other traditional metrics like BLEU (Bilingual Evaluation Understudy) scores or human judgment, and LLMs may be used as a judgement factor to assess various aspects of the output, such as accuracy, relevance, and even stylistic elements. In an embodiment, LLM based scoring is not limited to and considers for scoring relevance to content, question clarity, answer correctness, option plausibility, grammar and fluency, overall quality score, items generated etc. In an embodiment, score aggregation may involve combining individual scores from multiple sources or agents to produce a single, consolidated score, and may be useful when dealing with incomplete data or when individual scores are not sufficient for making accurate decisions. Partial result handling refers to the ability to process and utilize results even when some data is missing or unavailable and is crucial for systems dealing with large datasets or distributed processing where complete results may not be available immediately.

In an exemplary case, the item bank generally includes a repository of items, which may be grouped and/or categorized into different subject areas and/or topics, by one or more subject matter experts and/or by the AI/ML module and/or by the source. In an exemplary case, the item bank repository may be structured data, unstructured data or a combination thereof. In an exemplary case, the source may be configured to scrutinise, authenticate and validate each of the item(s) that are generated by the AI/ML module, and the decision with respect to the item(s) may be processed by the AI/ML module, which includes an action such as approving and/or disapproving and/or suggesting changes to the item(s) created by the AI/ML module. In an embodiment, the relevant action may be implemented by the AI/ML module. In an exemplary case, the source may provide feedback with respect to the item and/or a plurality of items, and the feedback may be routed to the AI/ML module, wherein the feedback may be used to update the AI/ML module or may be discarded, and when updated in the AI/ML module, the feedback will be used by the AI/ML module for self-learning and enhancing the capabilities of the AI/ML module. In an exemplary case, the source may be configured to offer suggestions as feedback to the AI/ML module to change the item that was generated by the AI/ML module, and such feedback may also be provided for continuous learning and improvement of the AI/ML module.

In an exemplary case, an item may include at least one of a dichotomous item type or a polychotomous item type. In an exemplary case, the dichotomous item type may be a True or False statement and not limited to the True or False type and may be a radio button type of selection to select the correct key or a multiple-choice item type. In an exemplary case, the polychotomous item type may include several different item types which may be and not limited to matrix multiple choice and/or multiple response type and/or match the following and/or highlight in text and/or any other item types that do not fall under the dichotomous item type. In an exemplary case, it should be obvious to a person of ordinary skill in the art that all items created/generated belong to and may be classified under the dichotomous item type or polychotomous item type. In an exemplary case, the level of difficulty of the item may be assigned by the source and/or the subject matter expert and/or an AI/ML module itself based on previous learnings and history. In an exemplary case, a question may have a low difficulty level, a medium difficulty level and a high difficulty level, with appropriate keys, where only three level are provided, and there could be many other levels, wherein each question and key forming an item may be assigned a score between 1 to 3, and may in general vary from −infinity to +infinity. The difficulty level may depend on framing of the stem and/or the keys and/or the category into which the item is categorised, where the difficulty score may be indicative of the degree of difficulty associated with the item. In an exemplary case, the item may include and not be limiting to at least one of a traditional item, a non-traditional item, a judgement item, a non-judgmental item, a clinical item, a non-clinical item, a next generation item, etc. It should be obvious to a person of ordinary skill in the art that various other categories may be envisioned and all such variation fall within the scope of the present disclosure.

As referred to herein, in an exemplary case, an ‘item’ in the context of the present disclosure generally refers to a question and a set of keys (hereinafter also referred to as answers) with respect to that question or a requirement for a key to be input to the question. In general, an item includes at least a question requiring a set of keys to be either selected from the provided set of keys or a question requiring an answer as a sentence or in words to be input as a key to the question, which may be labelled as paragraph type items. In an assessment, on completion of all the items being administered to the candidate, the accrual (complete set of answered items, also referred to as results) may be collected and uploaded on the server, and stored on the sever for any future disputes that may arise, where for example the server is test administration servers. In an embodiment, the accruals are used for assessment of the candidate, where assessment may be either done automatically by the AI/ML module of the computing system or by an examiner. In an exemplary case, the plurality of items may be referred to as a task presented to a candidate in an examination for the purpose of conducting a performance assessment of the candidate's skills, knowledge and/or proficiency in a particular subject or subject area. In an exemplary case, such items may be sourced from an ‘item pool’, or ‘item bank’ as variously referred to herein, which includes a pool and/or a collection of items approved or otherwise designated for testing and/or assessing a candidate.

In an exemplary case, the AI/ML module may categorize the items subject area wise/topic wise and the items may be stored in a repository (hereinafter may also include a database) from where the items may be selected to be administered to candidates for assessment or for creating the test package based on the requirements of the assessment. As discussed previously each item may be categorized into multiple subject areas and stored accordingly in the repository, which may be advantageously done by means of a mapping between the item and the subject area and/or the difficulty score, and for example the mapping may be a lookup table or some other relationship methodology. In an embodiment, the test package created for a candidate amongst other relevant details may include a plurality of items, wherein the items are selected by the source to be administered to the candidate for assessment of the candidate. In an exemplary case, each of the plurality of items in the test package may include a question and a key, wherein the key may either be selected from a list of keys provided along with the question or the key may be an input required to be provided by the candidate in response to the question.

Reference is now made to FIG. 1, which illustrates a high-level exemplary architecture 100 for creating (generating) items (exam items, knowledge assessment items) in accordance with an embodiment of the present disclosure. Architecture 100 includes a computing system 120, which has a memory, a processor and an AI/ML module, and computing system 120 may be configured to run an AI/ML module. AI/ML module of computing system 120 may be a software module or embedded hardware, such as a chip, or a firmware or a combination thereof. Embedded hardware herein generally refers to the physical, tangible parts of a device, like the processor, memory, and other electronic components, while firmware refers to software that provides low-level control and instructions for how this hardware functions. While firmware works directly with hardware, embedded software operates at a higher level. Computing system 120 may include at least a CPU (Central processing unit) and/or a GPU (Graphics Processing Unit) and/or a TPU (Tensor Processing Unit) and/or a DPU (Data Processing Unit) and/or NPU (Neural Processing Unit), memory, storage devices, and input/output units, other components and the function of these components of computing system 120 is to work together to process and store data, execute programs, and communicate with internal device and external devices. Computing system 120 may be specifically designed for generating items, specifically knowledge assessment items, as defined and discussed previously and as per the requirement of the source, and storing the items generated in an item bank after the items have been authenticated and vetted by an AI/ML module of computing system 120 or a subject matter expert.

Computing system 120 (which may also be hereinafter referred to as a computing device) is capable of receiving input 110 or is provided with specific input 110 from a source, wherein the input is a specific requirement for generating items in specific subject areas/topics by the AI/ML module. Input 110 may be devised as a query (Table 1 below) to AI/ML module devised for generating knowledge assessment items. Input may for example include a request specifying the requirements for generating the items. Input 110 may include multiple options such as mentioning subject areas, content links, number of items, item types, number of items in each item type etc., and may be provided in a structured format and/or an unstructured format and/or a combination thereof. It should be obvious to a person or ordinary skill in the art that input to AI/ML module may contain a large set of pre-defined parameters, which will be preprocessed by the AI/ML module, but the AI/ML module has a mandatory minimal requirement of the number of parameters to be specified to the AI/ML module for generating items, authenticating/vetting the items and storing and/or updating the items generated in an item bank. Input 110 to the AI/ML module may be in a structured format (and indicated in Table 1) or an unstructured format or a combination thereof. An exemplary input 110 provided to the AI/ML module may include and not be limited to the following query as illustrated in Table 1.

TABLE 1
SAMPLE INPUT PROVIDED TO THE AI/ML MODULE

Provide basic, intermediate and advanced level questions
Topics include Physics
Assign Difficult Score to items generated
Content Source - (may or may not be provided)
Provide items for the item types
Multiple choice - 10 (items)
Multiple response Select All -15
Multiple response Select N -15
Highlight In text - 10
Highlight in Table -20
Matrix Multiple choice -5
Matrix Multiple response -10
Cloze Drop Down -15
Table Drop Down - 5
Drop Down Rationale -10
Bow Tie -10
Ordered Response -15
True False -25
Radio button -25
Paragraph - 10
Paragraph with track changes - 5
Sample input, there could be other variation provided and may be in structured format and/or unstructured format and/or a combination thereof. The number alongside the item type specifies the number of items to be generated.
Item Types defined herein are only exemplary in nature, and the EXAMROOM.AI ® Application is currently configured to generate roughly about 180 item types from the input content.

The above illustrated input 110 format for generating items in Table 1 is only one exemplary case showing input 110 in a structured format with only a few parameters from the set of pre-defined parameters being specified therein. It should be obvious that various other forms may be devised for input 110 and provided to the AI/ML module, and all such variations fall within the scope of the embodiments of the present disclosure. The AI/ML module may be capable of deciphering the input into a meaningful format and subsequently check with the source before generating the items. As illustrated in the exemplary case several other parameters may also be included in the input based on the requirements of the items to be generated, for example under the header of Topics include—multiple topics may be provided to the AI/ML module, where instead of Physics, the input may include Physics and Electrical Engineering and a sub-level of topic classification subject area of electricity may be included. In another illustration the total number of items to be generated may be included. In an exemplary case, for purpose of illustration 16 items types are defined in the sample input and the number along side the item type may be indicative of the number of items to be generated under that particular item type.

In another illustration the number of items in each item type may be included. AI/ML module of computing system 120 is configured to scrutinize the input requirement and provide the requested output 130 to source, wherein the output from the AI/ML module includes at least an item. In an alternate case, content for generating the items may be provided to the AI/ML module. In an alternative case, if the subject area is mentioned and the content is not provided to the AI/ML module as part of the input, based on previous learnings of the AI/ML module, the AI/ML module may find relevant sources from past history and use at least one or more of the history content sources to generate items, which may be with and/or without confirmation from the source. In an alternate exemplary case, input 110 indicates “Provide basic, intermediate and advanced level questions”, but source may alter the input such that the AI/ML module may to be “Provide basic level questions” separately, “Provide intermediate level questions” separately and “Provide advanced level questions” separately. AI/ML module may also be configured to assign a difficulty score (also referred to as threshold score) to each of the items generated and/or may also request a subject matter expert to classify the items and define a difficulty score, and the AI/ML module may be configured to evaluate any such feedback from the subject matter expert and provide the feedback to the AI/ML module for future considerations, and may also include a human in the loop, and any feedback provided by the source is provided to the AI/ML module for self-learning and improvement, which learnings may be used in any future use of the AI/ML module for generating items. Again, it should be obvious to a person of ordinary skill in the art that several variations in structured format and/or unstructured format and/or a combination thereof may be provided as input 110 to AI/ML module of computing system and based on input 110, a relevant output 130 is provided to source.

In an exemplary case based on input 110, output 130 is provided to the source and/or subject matter for authentication and vetting the output before being updated into an item bank, and/or may also include assigning a difficulty score by the AI/ML module and/or by the subject matter expert. See Table-2 and Table-3.

TABLE 2
Multiple Choice (Single Correct)

| | |
|---|---|
| Subject: Physics | |
| Q: What is the SI unit of force? | |
| Options: | |
| A. Newton | |
| B. Pascal | |
| C. Joule | |
| D. Watt | |
| Answer: A | Difficulty Score - 2.153/3 |

TABLE 3
Multiple Choice (Multiple Response- Select all that Apply Correct)

| | |
|---|---|
| Subject: Physics | |
| Q: Which of the following are metals? | |
| Options: | |
| [symbol] Iron | |
| [symbol] Copper | |
| □ Sulfur | |
| □ Oxygen | |
| [symbol] Aluminum | Difficulty Score 1.752/3 |

In an exemplary case, any change made to the item and/or the difficulty score and/or any other parameters may be provided as feedback to the AI/ML module for reconsideration and implementation, which may be also considered for continuous improvement by self-learning by the AI/ML module. The above two illustration in Table 2 and Table 3 of output 130 are only exemplary cases that may be generated as part of the requirement based on the input 110, and it should be obvious to a person of ordinary skill in the art and all types of input requirements for items will be assessed by the AI/ML module, processed appropriately and generate a suitable output 130 for evaluation by a subject matter expert and after authentication and vetting by the subject matter expert, and may also include a human in the loop, and any feedback provided by the source is provided to the AI/ML module for self-learning and improvement, which learnings may be used in any future use of the AI/ML module for generating items, and the items may be uploaded to an item bank or a new item bank may be created.

In an illustrative case a particular category of items may be of a type that requires the candidate to provide an answer, such as an open question as illustrated below in Table 4

TABLE 4
Paragraph

Subject: Physics
Q: Explain the concept of inertia with an example from daily life.
Sample Answer: Inertia is the tendency of an object to resist a change in
its state of motion. For example, when a car suddenly stops, the
passengers lurch forward due to inertia.
Difficulty Score - 2.73/3

The sample key provided may be used by the AI/ML module to assess the candidate input provided and match the candidate answer with the standard answer provided. The assessment of such an open answer may be made by determining a similarity score or similarity measure with respect to the candidate answer and the key provided by the AI/ML module. Based on the similarity score determined between the candidate's answer (key) and the system key approved by the subject matter expert, decide whether the candidate's key is correct or incorrect. In an alternate case, such candidate's key may also be referred to a subject matter expert for verification and/or evaluation, and assessment made by the subject matter expert.

In an illustrative case a particular category of items may be of a type that requires the candidate to highlight the correct text as illustrated below in Table 5.

TABLE 5
Highlight in Text

Subject: Physics
Passage: Water is composed of two hydrogen atoms and one oxygen atom.
It is a universal solvent.
Q: Highlight the phrase that indicates the chemical composition of water.
Answer: two hydrogen atoms and one oxygen atom
Difficulty Score - 1.273/3

It should be obvious to a person of ordinary skill that the illustrated cases and there may be multiple other categories that are possible to be generated and all such variation are not illustrated in the present disclosure by fall within the scope of the present disclosure as long as the items broadly fall within the under the dichotomous item type or polychotomous item type.

In a exemplary case, input 110 may also be provided with content sources as part of the requirement by the source, which can be evaluated by the AI/ML module along with the other pre-defined parameters as discussed and illustrated previously. If the content source is inappropriate, the AI/ML module may intimate the source that the content source is inappropriate and/or incorrect and ask for a new alternative source to be provided and/or the AI/ML module based on the other requirements may automatically suggest content sources to the source. Based on input 110 received by computing system 120, the computing system processes input 110 and provide an output of 130 as illustrated previously, and output 130 in accordance with the embodiments of the present disclosure is specifically related to items(s), and more specifically related to knowledge assessment items (exam items). In one embodiment, fetching content (accessing content) based on input 110 by the AI/ML module, includes analyzing and/or understanding the content based on the input and the context and relevance of the content to the input. In one embodiment, the AI/ML module may be configured for key concept identifications by detecting the main concepts in the input content, which is gathered while pre-processing the input for generating the items.

In an embodiment, the AI/ML module may adapt at least one of a Retrieval-Augmented Generation (RAG) framework, a Knowledge Augmented Generation (KAG) framework, a model context protocol (MCP) framework, a generative AI framework, a transformer model framework. a deep learning model, an elastic weight consolidation (EWC) model, an instructor-based training model, progressive neural network model, a learning without forgetting model, a memory replay system model, a vector-based model, graph-based model, agentic framework, McCulloch-Pitts Neuron framework, Knowledge Distillation framework, Transfer Learning framework, Reinforcement learning framework and/or a combination thereof. It should be obvious to a person of ordinary skill in the art that several other AI/ML models may be used, and all such variations fall within the scope of the present disclosure. In an embodiment of the present disclosure additionally the AI/ML module may be configured for performing the methodology described above in an automated manner and/or a manually operated manner. In an exemplary case, the AI/ML module may be based on the input 110, advantageously prepare the items, verify the items, categorize the items into different item types and upload the items into relevant categories in an item bank.

In an embodiment, KAG, or Knowledge Augmented Generation, is an advanced AI framework that enhances large language models (LLMs) by integrating structured knowledge, particularly from knowledge graphs, to improve accuracy, contextual understanding, and reasoning capabilities, and builds upon the foundation of Retrieval Augmented Generation (RAG) by incorporating more sophisticated techniques like multi-hop reasoning and hybrid search, making it particularly suitable for professional domains where precision and in-depth knowledge are critical. In an embodiment, Retrieval-augmented generation (RAG) is a technique that enhances the capabilities of large language models (LLMs) by combining their generative abilities with information retrieval from external knowledge sources and essentially allows LLMs to access and utilize up-to-date and relevant information beyond their training data, leading to more accurate, context-aware, and reliable responses.

In an embodiment, transformers model framework acts as the model-definition framework for state-of-the-art machine learning models in text, computer vision, audio, video, and multimodal model, for both inference and training, and centralizes the model definition so that this definition is agreed upon across the ecosystem. In an embodiment, deep learning models are a subset of machine learning models that employ artificial neural networks with multiple layers (the reference being made to “deep”) to learn complex patterns and representations from data, and these models are inspired by the structure and function of the human brain, with interconnected “neurons” organized in layers. In an embodiment, elastic weight consolidation (EWC) refers to an algorithm that is analogous to synaptic consolidation for artificial neural networks which slows down learning on certain weights based on how important these weights have been to previously assigned and executed tasks.

In an embodiment, Instructor-led training (ILT) is a learning model where a trainer or instructor delivers educational content to learners in real-time, either in person or virtually, and it is configured to emphasize direct interaction and engagement between the instructor and learners, fostering a dynamic learning environment through feedback, discussions, and collaborative activities. In an embodiment, a Progressive Neural Network (PNN) is a neural network architecture designed to address catastrophic forgetting in lifelong learning and transfer learning, and this is achieved by adding new “columns” of neurons for each new task, while freezing the weights of previous columns to prevent them from being altered, and lateral connections between these columns allow for knowledge transfer between tasks. In an embodiment, Learning without Forgetting (LwF) framework is a technique in continual learning that aims to train a neural network to acquire new knowledge without losing previously learned information, and is designed to address problems associated with catastrophic forgetting, where neural networks tend to forget previously learned tasks when trained on new ones, and furthermore, LwF may in some instance use a concept of knowledge distillation, where a bigger model (referred to as a teacher) model attempts to teach a smaller model (referred to as a learner).

In an embodiment, vector-based models represent data as numerical vectors, enabling machines to understand and process complex information, and are fundamental in various applications like natural language processing, recommendation systems, and image recognition, wherein these models essentially convert data into vectors, and machines can perform operations like similarity comparisons, which are crucial for tasks like finding similar documents or recommending products. In an embodiment, vectors can be compared using mathematical techniques like cosine similarity, allowing for the identification of similar items. In an embodiment, McCulloch-Pitts (MP) neuron framework is a binary model that processes binary inputs and producing binary outputs, and is characterized by weighted connections and a threshold, and advantageously enables users to integrate AI capabilities across applications while maintaining clear security boundaries and isolating concern.

In an embodiment, Graph-based AI models may represent data as interconnected nodes and edges, allowing them to analyze relationships and dependencies within complex datasets, where Graph Neural Networks (GNNs) are generally used for tasks like node classification, link prediction, and graph classification. In another embodiment, agentic framework provides the structure and rules for building autonomous AI agents that can act with limited human direction and define how agents perceive inputs, process information using algorithms or large language models, and then execute actions, which are essential for creating complex AI systems where agents need to interact, reason, and adapt within dynamic environments.

In an embodiment, the AI/ML module comprises at least one of a context-awareness precision framework, a Pedagogically Intelligent framework, a Continuous Improvement framework, a Domain-Agnostic scalability framework, a Higher-Order Thinking Support framework and an Instant Update framework. Context awareness precision within the embodiments of the present disclosure refers to an AI/ML system's ability to understand and respond to information beyond the immediate input, taking into account the broader environment, user history, and relevant background information, and is about creating AI/ML systems that can adapt to changing circumstances and provide more relevant and personalized responses, like humans do when they consider the context of a situation. Pedagogical intelligence within the embodiments of the present disclosure refers to the ability to effectively understand, apply, and adapt teaching and learning principles to enhance educational outcomes. It encompasses a deep understanding of learning processes, individual differences, and various instructional strategies, and is the skill of using intelligent methods to facilitate learning, including adapting to diverse student needs and leveraging technology. “Continuously improvising” within the embodiments of the present disclosure refers to the ongoing and iterative process of making incremental improvements, often in response to new situations or feedback, and is a dynamic approach where adjustments are made on a regular basis to enhance performance, adapt to changing circumstances, or refine existing processes. This can be applied to various areas, from personal development to business strategies.

Domain-agnostic scalability and learning within the embodiments of the present disclosure refers to a learning paradigm where a model is trained to perform well across multiple, diverse domains without requiring domain-specific knowledge or adaptations, and is in contrasts with traditional machine learning, where models are often tailored to specific data distributions and may struggle when faced with new, unseen domains, and the goal is to create models that are robust and generalizable, capable of handling variations in data characteristics, input formats, and problem types across different contexts. Bias-Reduced within the embodiments of the present disclosure relate to mitigate bias in AI, strategies include using diverse datasets, employing fairness-aware algorithms, and implementing ongoing auditing and monitoring, and involves preprocessing data to be representative, integrating human oversight through auditing and transparency mechanisms, and developing responsible AI platforms that incorporate bias detection. Higher-order thinking (HOT) support within the embodiments of the present disclosure refers to cognitive skills that go beyond basic recall and comprehension, and it includes applying knowledge, analyzing information, evaluating arguments, and creating new ideas. Multi-answer questions, especially those requiring analysis, evaluation, or synthesis, can be effective tools for promoting HOT in educational settings. Instant Updates within the embodiment of the present disclosure generally refers to the ability to quickly and efficiently apply changes or updates, often in real-time, without significant delays or the need for a full application reinstallation, and may apply to various contexts, including software, websites, and even physical products. It should be obvious to a person of ordinary skill in the art that one of more of these techniques previously discussed and principles may be used either singly or in combination with the embodiment of the present disclosure to generate items from a content source and input requirements specified to the AI/ML module. In an embodiment, the generated items are automatically fixed by the AI/ML module into item type categories and/or the language of the questions and/or keys is appropriately fixed based on previous learning and/or if a difficult score has to be fixed, then the AI/ML module may from previous learning fix the difficult score.

In an exemplary case, a correlation coefficient may be determined for each of the keys provided, especially when the key includes an answer provided by the candidate, and the correlation coefficient defines a minimal threshold value associated with keys provided by the candidate and the pre-stored key as determined by the AI/ML module. In an exemplary case, the correlation coefficient defined a numerical measure that describes the strength and direction of a relationship and typically ranges from −1 to +1. In an exemplary case, +1 indicates a positive correlation, wherein when one variable increases the other increases, −1 indicates a negative correlation, wherein when one variable increases the other variable decreases, and 0 indicates no linear correlation. In an exemplary case the closer the coefficient is to +1 or −1, the relationship is stronger and a coefficient closer to 0 indicates a weak or no linear relationship. In an exemplary case, it should be obvious to a person of ordinary skill in the art that there are different types of correlation coefficients, with Pearson's product-moment correlation coefficient being the most common for linear relationships, and other types include Spearman's rank correlation coefficient for monotonic relationships (where the variables tend to move in the same direction, but not necessarily linearly), Cramer's V correlation which identical to Pearsons coefficient, Concordance Correlation Coefficient, Intraclass Correlation, Kendall's Tau, Moran's I, Partial Correlation, Phi Coefficient, Point Biserial Correlation, Zero-Order Correlation and all such variations of correlation coefficient may be used for the embodiments of the present disclosure and all such variations fall under the scope of the embodiments of the present disclosure. In an exemplary case, determining the correlation coefficient assists the examination administrator or the proctor in assessing how changes in one variable can predict changes in another variable, and a high correlation does not necessarily imply causation.

In an exemplary case, Pearson correlation coefficient (r) may be computed using the formula, if x and y are two variables

$$r = \sum [ ( {x}_{i} - \overline{x} ) ( {y}_{i} - \overline{y} ) ] / √ [ \sum {( {x}_{i} - \overline{x} )}^{2} \sum {( {y}_{i} - \overline{y} )}^{2} ] ,$$

where xᵢ and yᵢ are the data points, and x and y are the means of the respective variables under consideration. If the correlation coefficient value is positive, then there is a similar and identical relation between the two variables, else the indication is that there is dissimilarity between the two variables. It should be obvious to a person of ordinary skill in the art that correlation coefficient values typically range from −1 to 1, where a correlation coefficient value close to 1 shows a very positive string relationship for the two variables and a correlation coefficient value close to −1 indicates a negatively strong relationship for two variables. It should be obvious to a person of ordinary skill in the art that similarly other correlation coefficients may be computed based on the algorithm used and all such algorithms and correlations fall within the scope of the present disclosure.

In an exemplary case, computing system 120 may include any device that has at least a processor and a memory, and also in accordance with the embodiment of the present disclosure computing system 120 may additionally include an AI/ML module and/or computing system 120 may be coupled to an AI/ML module, where the AI/ML module is not part of same computing system 120 where the AI/ML module may be a separate module hosted separately from computing system 120, and may be coupled with the computing system, and in such cases the AI/ML module uses the resources of the computing system to perform the task of generating items as required by the source in accordance with the embodiments of the present disclosure. The AI/ML module may be a software module, a hardware module with embedded code, a firmware and/or a combination thereof. It should be obvious to a person of ordinary skill in the art that the embodiment of the present disclosure are related to generating items using a AI/ML module, preferably using a trained AI/ML module, and any AI/ML algorithm and/or AI/ML tools readily available may be customized for the purpose, which creates items from content from an input 110 provided by the source.

In an exemplary case, the AI/ML module may be custom built and designed for the specific purpose of creating items from content and set of pre-defined parameters provided as input by a source and any other specific inputs provided by the source. It should also be obvious to a person of ordinary skill in the art that any computing system 120 having at least a processor and a memory and configurable to perform the operation as defined in the embodiments of the present disclosure include and is not limited to laptop computers, mobile phones, PDAs, desktop computers, servers etc., and essentially may include a device that may include a CPU and/or a GPU and/or a TPU and/or a DPU and/or a NPU with a memory, and the computing system may additionally host the AI/ML module, and all such devices fall within the scope of the present disclosure. It should also be obvious to a person of ordinary skill in the art that the AI/ML module may be a separate system, that may be coupled to computing device 120 via a wired network and/or a wireless network and/or a combination thereof, and all such variations fall of separated systems that may be distributed within a network or any could-based system that may be employed to generate items with an AI/ML module fall within the scope of the present disclosure. In general source as referred herein may refer to an examination administrator, a client, a teacher, a third party acting on behalf of a client or any other authorized person such as a subject matter expert and in the present disclosure may also be essentially referred to generally as a ‘user’ who provides input 110 and requires items to be generated from the input provided.

Computing system 120 as mentioned previously may be any device which includes a CPU and/or a GPU and/or a TPU and/or a DPU and/or an NPU with a memory and may be a networked system that may be connected to the Intranet and/or Internet for fetching content and connecting with an item bank repository. However, it is contemplated that, as will be appreciated by a person of ordinary skill in the art, that at least some portions of logic componentry and functionality ascribed to computing system 120. Computing system 120 may be coupled with network over a wired connection and/or a wireless connection and/or a combination thereof. AI/ML module of computing system 120, which includes logic, which may be implemented using programmable instructions stored in memory of computing system that are executable in one or more processor devices, including such as and not limited to processor. Memory may include, though not necessarily be limited to, non-volatile memory device(s), including dynamic Random Access Memory (DRAM) or Static Random Access Memory (SRAM) non-transitory memory storage media or devices, and/or any combinations thereof. Although functionality ascribed to AI/ML module of computing system 120 is described herein, for sake of providing clarity to a person of ordinary skill in the art, in context of a single discrete logic module, it is expected that functionality ascribed to AI/ML module herein should not be limited in implementation to such literal configuration and may be constituted of a plurality of functionally equivalent modules. In some variations, at least some portions of functionality of AI/ML module of computing system 120 may be implemented in accordance with hard-wired circuitry and/or electronic componentry. The hard-wired circuitry and/or electronic componentry may be, without limitation, such as field programmable gate array (FPGA) devices, application specific integrated circuit (ASIC) devices and similar hard-wired electronic circuitry and/or componentry device implementations.

In an exemplary case, AI/ML module of computing system 120 includes processor-executable instructions stored in memory, which, when executed in processor, cause processors to implement operations as disclosed previously of receiving input, pre-processing the input, processing the input and generating items as output as required by the input specified by the source. AI/ML module of computing system includes processor-executable instructions stored in memory, which, when executed in processor, cause processor to implement operations for continuously generating items, specifically knowledge assessment items as disclosed in the embodiments of the present disclosure.

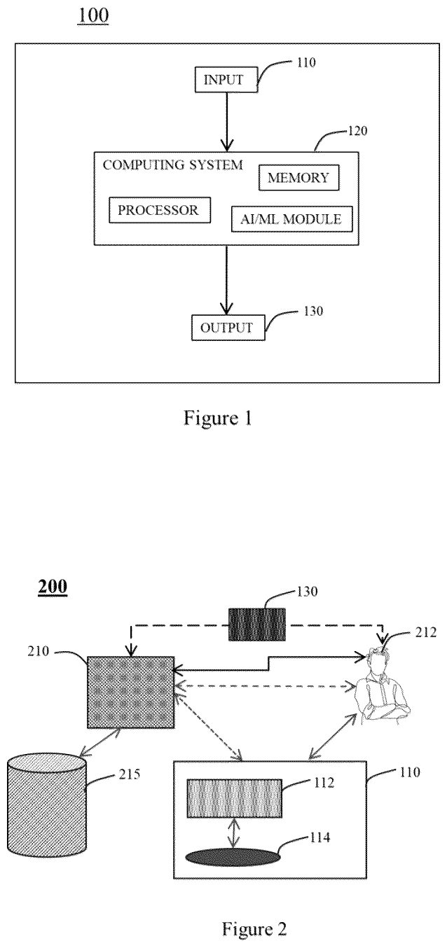

Reference is now made to FIG. 2, which illustrates an exemplary environment 200 (architecture) for generating (creating) items (knowledge assessment items or exam items) in accordance with an embodiment of the present disclosure. Environment 200 (hereinafter also referred to as architecture) includes source 212, wherein source 212 may be a user who is desirous of generating items from content using the AI/ML module of computing system 120 (as described with reference previously in FIG. 1). The AI/ML module may be configured to automatically generate items from content 112, which may not be mandatory, and a set of pre-defined parameters 114, which are input parameters required for generating the items, and at least some of the pre-defined set of parameters are mandatory as input to the AI/ML module for generating an output, which in this case is knowledge assessment items (the list of pre-defined parameters has been defined in details with respect to FIG. 1, and has been generally referred to as input 110, based on which the items are created). In case content is not provided as part of the input to the AI/ML module, the AI/ML module, based on the input provided and the intelligence derived from past learnings, search and automatically fetch appropriate relevant content for creating the items. Consent may be obtained for using the relevant content fetched for generating the items. In another alternate case, the AI/ML module may automatically use multiple sources, which may be derived from the intelligence obtained from self-learning and pre-stored learning information and data to obtain content in the relevant area/topic/subject for generating the items.

Source 212 as discussed previously may include at least one of and not be limited to a subject matter expert, a teacher, an examining authority (administrator), a client, a third party acting on behalf of the client, any other authorized person etc., and in general would also be referred to as a user who would have the requirement to generate items form relevant content using the AI/ML module as envisioned and disclosed under the embodiments of the present disclosure. Input 110 to AI/ML module at least includes relevant content 112 and a set of pre-defined parameters 114 (also hereinafter referred to as parameters or other parameters or simply as input), wherein at least a few parameters from the set of pre-defined parameters are mandatory requirements as input to the AI/ML module for generating items, failing which the AI/ML module will not be able to generate items. In an exemplary case, at least a few of the pre-defined parameters from the set of pre-defined parameters are provided for the AI/ML module to generate items as disclosed in Table-1 of FIG. 1.

In the case no input parameters from the pre-defined set of parameters required to generate items are provided by the source, and the source requires items to be generated, the source may use a keyword as a starting point for the AI/ML module to begin interacting with the source to suggest these parameters from past learnings. In an exemplary case, the AI/ML module would require at least a single statement such as “Generate items” or “create knowledge items”, to initiate an action, which indicates to the AI/ML module that knowledge assessment items need to be created. As mentioned, at least one parameter or a generic parameter must be provided as input for the AI/ML module to direct and prompt source 212 to obtain at minimal set of pre-defined parameters for generating items. Based on input 110, which may include the relevant content and the set of pre-defined parameters, AI/ML module may be configured to generate item(s) as per the requirement of source 212 as disclosed previously with respect to FIG. 1, wherein the items are based on the requirement specified by source 212.

Content 112 may include and not be limited to at least one of an audio source, a video source, an audio-visual source, a journal, a book, webpages, links, any multi-media source, optical discs and other sources of content stored and mapped into server etc. In an exemplary case, if content 112 is identified as a book, an online copy of the book may be provided to computing system 210. In an alternative exemplary case, content 112 may be input to computing system 120 by means of an optical scanner (not shown in figure), where the optical scanner may be coupled to the computing system 210, and the optical scanner being configured to read the part of the content in the book and provide content 112 as part of input 110 to AI/ML module of computing system 120 in addition to the set of pre-defined parameters for generating item(s) as required by source 212. In an exemplary case, it should be obvious to a person of ordinary skill in the art that content 112 may be provided by various other alternative means to computing system 120, which are not discussed and/or presented in the present disclosure, and all other means being used by source 212 to provide content 112 to computing system 210 for the specific purpose of generating items(s) falls within the scope of the embodiments of the present disclosure.

Input 110 include other parameters 114 (also referred to as set of pre-defined parameters or set of parameters) to be specified to the AI/ML module, wherein the other parameters may include and not be limited to the set disclosed previously in Table-1. In an exemplary case, it should be obvious to a person of ordinary skill in the art that at least a minimal number of parameters 114 may be required as an input 110 by the AI/ML module of computing system 210 for generating the exam items in accordance with the embodiments of the present disclosure. In an alternate case, when there is no input 110 provided by user, AI/ML module of computing system 210 may prompt the source 212 to obtain a minimal set of parameters, such that the AI/ML module of computing system may be configured to generate items from the content.

The AI/ML module may be hosted within computing system 210 as part of the computing system or may be hosted separately on another device and coupled to computing system 210 by wired means and/or wireless means and/or a combination thereof. The AI/ML module is trained and continuously finetuned with the feedback from the source for the purpose of creating (interchangeably used as generating) items (knowledge assessment items or exam items) by receiving input 110 from source 212. When input 110 is of desired format and a minimal required set of parameters has been provided to the AI/ML module for generating items, the AI/ML module is configured to provide an output 130, wherein the output is items generated based on the requirement provided source. The items(s) generated as output 130 may be provided back to source 212 to analyze, scrutinize, validate and approve the item(s) created, and also any associated feedback provided by source may be collected and provided back to the AI/ML module for self-learning and/or self-training of the AI/ML module.

Source 212 based on output 130 received from computing system 210, may request a change to the item(s) generated by the AI/ML module after reviewing the item(s). Any item requiring change may be provided back to AI/ML module with a change request and reason and/or feedback, wherein the change request from the user is used to revise the item, and the feedback may or may not be used. When the AI/ML module uses the feedback, the AI/ML module self-learns and self-train incorporating the feedback for improvement of the AI/ML module. The AI/ML module may consider feedback and adapt the feedback provided, and upon detecting similar instances of input from a source at a future point in time, the AI/ML module may use the previous learnings to adapt and perform the required tasks of generating items. The AI/ML module is also additionally configured to identify duplicate and/or multiple items in the same item type category and discard the duplicate and/or multiple items that may be generated in the same item type category, such that duplicated items are not provided to the source for reviewing in the same item type category.

In an embodiment, the item may include at least a traditional item, a non-traditional item, a judgement item, a non-judgmental item, a clinical item, a non-clinical item, a next generation item. Each item created by the AI/ML module may be at least one of a dichotomous item type or a polychotomous item type as discussed previously. In an exemplary case, the item generated may be at least one of and not limited to a traditional item, a clinical judgement item, a next generation item or any other type of item as discussed previously. Once the item(s) that has been created by the AI/ML module is scrutinized, vetted and/or authenticated by source 212, appropriate further action and processing may be initiated by the AI/ML module of redirecting the item(s) and storing the item(s) in a repository 215. Each of the item generated by the AI/ML module may be classified into different subject area and/or topics and may be automatically placed in relevant categories and/or may be classified and categorized with the help of source 212. The collection of items may create an item pool (also referred to as item bank), which may also be referred to as an item bank repository (Repository). Repository 215 may include one or more item banks and other data in addition, but reference to repository 215 herein is reference specifically made to the item bank and/or item pool. Source 212 may be provided with rights and privileges to scrutinise and/or validate and/or approve the item created by the AI/ML module and provide feedback on the item(s) to the AI/ML module, as disclosed previously. The feedback provided to the AI/ML module is used for continuous learning and improvement of the AI/ML module. It should be obvious to a person of ordinary skill in the art that any available AI/ML algorithms and/or modules and/or tools may be configured and customized to execute the above-mentioned method for generating items, and all such AI/ML algorithms and/or modules and/or tools fall within the scope of the embodiments of the present disclosure.

Repository 215 includes an item bank, where the item bank may include a number of items under various subjects (refers to subject areas) and topics, and item(s) may be classified and categorized by source 212 and updated by AI/ML module. Alternatively, the AI/ML module may be configured to suggest the category for each of the item(s) and on validation of the subject/topic category and the item by source 212, the AI/ML module may dynamically update repository 215 with the items in the item bank. Updating of repository 215 with item(s) may be performed automatically and/or on instruction of source 212. Further, the AI/ML module receives as input at least one item type from the source and based on the item type the AI/ML module may be configured to generate at least or more one item(s) but is restricted to the total number of items requested by source 212. Repository 215 may contain items such as structured data, unstructured data or a combination thereof.

In an exemplary embodiment, the method and system for dynamically generating exam items may include receiving as input from a source at least pre-defined parameters, wherein based on the pre-defined parameters the items are generated. In an exemplary embodiment, the AI/ML module may be trained to perform various actions, and only a few of these actions may be pertinent to the embodiments of the present disclosure have been disclosed previously and any additional capabilities of the AI/ML module of computing system not disclosed herein also fall within the scope of the embodiments of the present disclosure. In the exemplary embodiment, the action of the AI/ML module may include identifying the pre-defined set of parameters required to create items and use the pre-defined parameters to generate items. In an exemplary embodiment, another action may determine the subject matter relevant to the item such that the AI/ML module may perform a further search to fetch related content, for generating new items.

In an exemplary embodiment, a collection of items created by the AI/ML module after being vetted by a human expert may be collated to form an item bank (also referred to as a repository), wherein the item bank may be specifically owned by an organization, such as a University or an examination authority or a corporate or may be a common item bank maintained by an examination authority such as EXAMROOM AI® who is proficient in conducting the examination/assessments on behalf of the various organizations as a mediator, or the item bank may be owned by any authority such as EXAMROOM AI® or any other organization having a common exam item bank, which may be licensed to any one of the above mentioned organizations.

In an exemplary embodiment, the content fetched by the AI/ML module may be a book or papers or chapters from a book, webpage, journals, online content, an optical disc, any multi-media source etc., which may be provided either online or may be provided via scanner or maybe a repository etc. It should be obvious to a person of ordinary skill in the art that input content may be provided by various means over a communication network or via a port, such as a USB port etc., and all such variation fall within the scope of the present disclosure. In an exemplary embodiment, the content may be provided as a link from the Internet or book on a USB which may be coupled to an AI/ML module containing software and/or hardware and/or firmware that is configured to read the content, determine the relevant content and generate exam items automatically from the content identified. In another exemplary embodiment, content may be provided by means of a scanner wherein the AI/ML module may be configured to read the content and create items for an item bank from the content provided. Several other variations may be possible, and it should be obvious to a person of ordinary skill in the art that all such variations fall within the scope of the present disclosure.

Items thus created are used to populate an item bank, after verifying that the items are new or a newer version of an already existing item has been created, such that the items stored in the item bank may be used for the purpose of conducting assessments and/or examinations in particular for assessment of candidates. Each item may also be stored with a difficulty level or difficulty score that may be associated with it as discussed previously. Items may also be prepared in accordance with templates that are already designed by the user or any other specific client who requires the exam items to be prepared in a proprietary format.

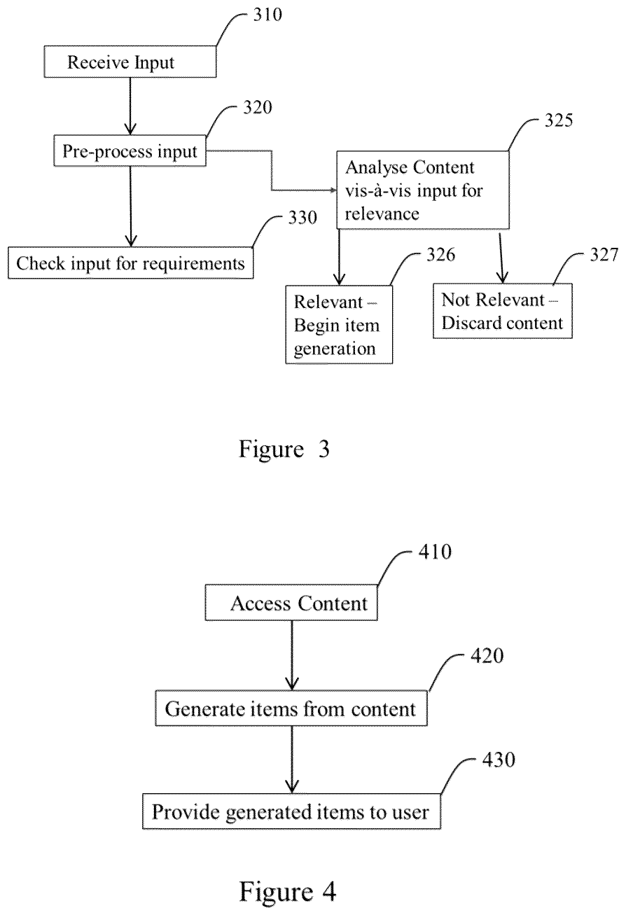

Reference is now made to FIG. 3, which illustrates an exemplary method of providing inputs to computing system comprising AI/ML module configured for assessing the parameters and generating knowledge assessment items in accordance with the embodiments of the present disclosure. In step 310 the computing system which includes the AI/ML module is configured to receive inputs, also referred to as a pre-defined set of parameters and ensures that at least a minimal set of pre-defined parameters are provided to the AI/ML module for generating items. Input should at a minimal requirement include at least one or more item types to be generated and at least one or more subject areas in which the items are required to be generated. As discussed previously several other parameters may be provided to the AI/ML module for generating items, and all such parameters provided to the AI/ML module fall within the scope of the embodiments of the present disclosure. An exemplary input provided to the AI/ML module is discussed previously with respect to Table 1. In an exemplary case, if the source/user is not capable of providing inputs to the AI/ML module, the AI/ML module may guide the user in a way that the requirements are captured so that items may be generated by the AI/ML module. Again, it should be obvious to a person of ordinary skill in the art that even if the parameters are captured by the AI/ML module, at least a minimal set of parameters are required for generating the items. In an exemplary case, the input provided to the AI/ML module be in a structure format and/or an unstructured format and/or a combination thereof.

In step 320, the input once provided to the AI/ML module of computing system, is preprocessed by the module to determine the requirements. In an exemplary case, preprocessing may include the process of transforming raw input data received from source into a clean, structured, and usable format by the AI/ML module, such that the AI/ML module may make efficient use of the input data for analysis and generating the items as required by the source. Pre-processing is a crucial step because raw input data often contains errors, inconsistencies, and irrelevant information that can negatively impact the accuracy and reliability of results. In an exemplary case, preprocessing may assist in cleaning the data by addressing missing values, inconsistencies, and noise, and preprocessing can also reduce the computational complexity of training machine learning models, leading to faster training times and faster generation of results. Preprocessing may include and not be limited to data cleaning, data transformation, feature selections, dimensionality reduction, outlier handling etc. In an embodiment, fetching content additionally includes analyzing the content for relevance and discarding the content with or without consultation of the source if the content is not relevant to the input query. In an exemplary case, if the input specifies subject area Physics and electricity, and if the content fetched is general physics related to optics, the content is found to be irrelevant to the subject area, and the AI/ML module may be configured to discard the content. In step 325 the content fetched by the AI/ML module or alternatively provided by the source may be analyzed for relevance with respect to the input. In step 326, if the content is identified to be relevant to the input, the content is used for generating items. In step 327, if the content is found to be irrelevant to the input, the AI/ML module may discard the content and/or intimate the source regarding such finding, and ask for a check from the source, and the feedback provided by the source will be provided back to the AI/ML module for further learning. In step 330, once the input data is preprocessed, a routine data check may be performed on the data to ensure that the AI/ML module will generate the items as per the requirements. These steps have been previously discussed with respect to FIG. 1 and FIG. 2.

Reference is now made to FIG. 4, which illustrates an exemplary method for assessing the parameters and generating knowledge assessment items in accordance with the embodiments of the present disclosure. Once the data is ready for generation of item as discussed in FIG. 3, in step 410, the relevant content is accessed, which may be done automatically by the AI/ML module, or the source may be prompted by the AI/ML module to provide the source to the content. The AI/ML module accesses the content and determines whether the content is relevant or not relevant (FIG. 3, Step 326, 327). In one exemplary embodiment, if the content is not relevant the AI/ML module will intimate the user and halt processing the items. If the content accessed is not relevant, the AI/ML module may discard the content that is not relevant and fetch content that is relevant to the subject area and the input requirement. The AI/ML module will use the relevant content to further process the input requirements from the relevant content to generate the items. In step 420, once the content is determined to be relevant and/or authentic, and/or the content has previously been vetted by the source for a previous case, the AI/ML module is configured to generate items as per the requirements in the item types using the content. In step 430, the generated items are provided as an output to the source, wherein the AI/ML module also checks for duplicate items in the same item type category and deleting the duplicate or multiple items. The items provided to the user are further processed either by the AI/ML module automatically or by a subject matter expert. In an exemplary case, the EXAMROOM.AI® application is configured to generate a large number of item types that include all item type categories, if the item type is not mentioned or specified in the input. Alternatively, as illustrated in Table 1, if the item types are specified, then the specific item types are created/generated by the AI/ML module. In an embodiment, the items generated in the item type category specified in the input may be provided to a source such as a subject matter expert, such as including a human in the loop, and any feedback provided by the source is provided to the AI/ML module for self-learning and improvement, which learnings may be used in any future use of the AI/ML module for generating items.

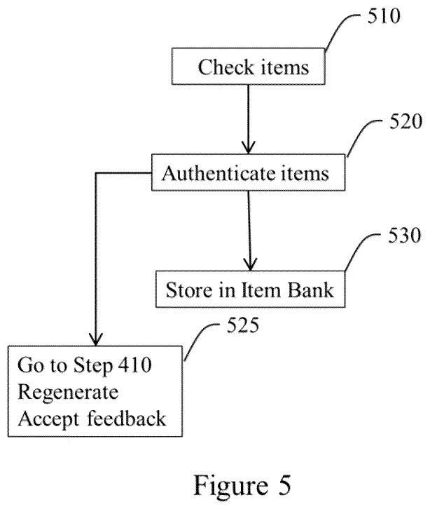

Reference is now made to FIG. 5, which illustrates a method for authenticating the generating knowledge assessment items and updating the item bank in accordance with the embodiments of the present disclosure. In step 510, the generated items are reviewed by the AI/ML module or by a subject matter expert. In step 520, the items are authenticated by the trained AI/ML module and/or a human subject matter expert, wherein the items and the difficulty associated with the items is checked and may be reassigned and in case of any corrections, feedback is provided to the AI/ML module for self-learning. In step 525, if the items are not acceptable or there is any feedback with respect to the item, the control is transferred to step 410 for regeneration of the item as per the new feedback and the feedback is updated into the AI/ML module for self-learning. In step 530, once the item is authenticated and vetted either by the AI/ML module and/or the subject matter expert, the item is categorized and stored in the item bank.

Although the present disclosure has been described with reference to several preferred embodiments, it should be understood that the present disclosure is not limited to the preferred embodiments disclosed here. Embodiments of the present disclosure are intended to cover various modifications and equivalent arrangements within the spirit and scope of the appended claims. Although the foregoing disclosure has been described in some detail for purposes of clarity of understanding, it will be apparent that certain changes and modifications may be practiced within the scope of the appended claims. Examples of the present disclosure have been described in language specific to structural features and/or methods. It should be noted that there are many alternative ways of implementing both the process and apparatus of the present invention. Accordingly, embodiments of the present disclosure are to be considered illustrative and not restrictive, and the invention is not to be limited to the details given herein but may be modified within the scope and equivalents of the appended claims. It should be understood that the appended claims are not necessarily limited to the specific features or methods described. Rather, the specific features and methods are disclosed and explained as examples of the present disclosure.

What is claimed is:

1. A method for dynamically generating knowledge assessment items, the method comprising:
an artificial intelligence/machine learning (AI/ML) module, the AI/ML module configured for
receiving as input from a source at least one or more knowledge assessment item type and a subject area, wherein knowledge assessment items are generated from the input provided to the AI/ML module, wherein the input is at least in one a structured format, an unstructured format and a combination thereof;
based on the input provided to the AI/ML module, the AI/ML module configured for:
fetching relevant content from at least one or more content sources relevant to the subject area;
dynamically creating at least one or more knowledge assessment items in the one or more knowledge assessment item type, wherein the at least one or more knowledge assessment items output comprises at least one of a dichotomous type and a polychotomous type; and
providing as output from the AI/ML module the at least one or more knowledge assessment items created to the source.

2. The method of claim 1, wherein content is fetched from at least one of a local source or a repository or an internet site or an intranet site or a book or a journal or a multi-media source or an audio source or a video source or an audio-visual source or a combination thereof.

3. The method of claim 1, wherein the source comprises at least one of an examination administrator, a client, a third party acting on behalf of the client, an authorized person acting on behalf of the client and a subject matter expert.

4. The method of claim 1, wherein the knowledge assessment items generated by the AI/ML module are authenticated and vetted by the source prior to updating the knowledge assessment items to an item bank.

5. The method of claim 4, wherein at least one of the AI/ML module or the source assigns a difficulty score for each of the knowledge assessment items generated, wherein at least one of the AI/ML module automatically assigns a difficult score to the knowledge assessment item, the source uses human knowledge with expertise to assign a difficulty score to the knowledge assessment item, the source uses human knowledge with expertise and guideline provided by the AI/ML module to assign a difficulty score to the knowledge assessment item and the difficulty score assigned by the AI/ML module can be overridden by the source assigning a new difficulty score.

6. The method of claim 5, wherein the difficulty score assigned to a knowledge assessment item varies for different item type, wherein the difficulty score for the knowledge assessment item in a first item type varies from the difficulty score for the knowledge assessment item in a second item type, wherein the first item type is different from the second item type.

7. The method of claim 1, wherein fetching content comprises at least one of:
automatically fetching content in the relevant subject area, and requesting the source to manually provide the content in the relevant subject area; and
preprocessing the content by the AI/ML module to validate the content.

8. The method of claim 1, wherein the knowledge assessment item comprises at least a stem, at least a set of keys, at least a set of distractors, and at least an input requirement to be provided by a candidate for a stem.

9. The method of claim 1, further comprising eliminating duplicates items generated in at least one of a same item type category, the dichotomous item types and the polychotomous item types.

10. The method of claim 1, wherein the AI/ML module comprises performing at least one of a Retrieval-Augmented Generation (RAG) framework, a Knowledge Augmented Generation (KAG) framework, a Model context protocol (MCP) framework, a generative AI framework, a transformer model framework. a deep learning model, an elastic weight consolidation (EWC) model, an instructor-based training model, progressive neural network model, a learning without forgetting model, a memory replay system model, a vector-based model, graph-based model and McCulloch-Pitts Neuron framework, agentic framework, Knowledge Distillation framework, Transfer Learning framework, and Reinforcement learning framework for generating items.

11. A system comprising at least a processor and a memory, the system further comprises an artificial intelligence/machine learning (AI/ML) module, the AI/ML module configured for
receiving as input from a source at least one or more knowledge assessment item type and a subject area, wherein knowledge assessment items are generated from the input provided to the AI/ML module, wherein the input is at least in one a structured format, an unstructured format and a combination thereof;
based on the input provided to the AI/ML module, the AI/ML module configured for:
fetching relevant content from at least one or more content sources relevant to the subject area;
dynamically creating at least one or more knowledge assessment items in the one or more knowledge assessment item type, wherein the at least one or more knowledge assessment items output comprises at least one of a dichotomous type and a polychotomous type; and
providing as output from the AI/ML module the at least one or more knowledge assessment items created to the source.

12. The system of claim 11, wherein content is fetched from at least one of a local source or a repository or an internet site or an intranet site or a book or a journal or a multi-media source or an audio source or a video source or an audio-visual source or a combination thereof.

13. The system of claim 11, wherein the source comprises at least one of an examination administrator, a client, a third party acting on behalf of the client, an authorized person acting on behalf of the client and a subject matter expert.

14. The system of claim 11, wherein the knowledge assessment items generated by the AI/ML module are authenticated and vetted by the source prior to updating the knowledge assessment items to an item bank.

15. The system of claim 14, wherein at least one of the AI/ML module or the source assigns a difficulty score for each of the knowledge assessment items generated, wherein at least one of the AI/ML module automatically assigns a difficult score to the knowledge assessment item, the source uses human knowledge with expertise to assign a difficulty score to the knowledge assessment item, the source uses human knowledge with expertise and guideline provided by the AI/ML module to assign a difficulty score to the knowledge assessment item and the difficulty score assigned by the AI/ML module can be overridden by the source assigning a new difficulty score.

16. The system of claim 15, wherein the difficulty score assigned to a knowledge assessment item varies for different item type, wherein the difficulty score for the knowledge assessment item in a first item type varies from the difficulty score for the knowledge assessment item in a second item type, wherein the first item type is different from the second item type.

17. The system of claim 11, wherein fetching content comprises at least one of:
automatically fetching content in the relevant subject area, and requesting the source to manually provide the content in the relevant subject area;
preprocessing the content by the AI/ML module to validate the content.

18. The system of claim 11, wherein the knowledge assessment item comprises at least a stem, at least a set of keys, at least a set of distractors, and at least an input requirement to be provided by a candidate for a stem.

19. The system of claim 1, further comprising eliminating duplicates items generated in at least one of a same item type category, the dichotomous item types and the polychotomous item types.

20. The method of claim 11, wherein the AI/ML module comprises performing at least one of a Retrieval-Augmented Generation (RAG) framework, a Knowledge Augmented Generation (KAG) framework, a Model context protocol (MCP) framework, a generative AI framework, a transformer model framework. a deep learning model, an elastic weight consolidation (EWC) model, an instructor-based training model, progressive neural network model, a learning without forgetting model, a memory replay system model, a vector-based model, graph-based model and McCulloch-Pitts Neuron framework, agentic framework, Knowledge Distillation framework, Transfer Learning framework, and Reinforcement learning framework for generating items.
